(19) United States
(12) Patent Application Publication
(10) Pub. No.: US 2009/0299964 A1
(43) Pub. Date: Dec. 3, 2009

(54) PRESENTING SEARCH QUERIES RELATED TO NAVIGATIONAL SEARCH QUERIES

(75) Inventors: MICHAEL MAXWELL CAMERON, REDMOND, WA (US); HUGH EVAN WILLIAMS, REDMOND, WA (US); SRINATH REDDY AALETI, REDMOND, WA (US); NITIN AGRAWAL, REDMOND, WA (US); TABREEZ GOVANI, SAMMAMISH, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 12/130,212

(22) Filed: May 30, 2008

(51) Int. Cl. G06F 17/30

(52) U.S. Cl. 707/3; 707/E17.014

(57) ABSTRACT

A method and medium are provided for determining whether search queries issued to a search engine are navigational search queries and displaying related search queries and corresponding URLs in association with a URL corresponding to a target of the navigational search query. One embodiment of the method includes receiving a query log and determining whether search queries are navigational search queries based on a comparison of URLs selected in response to the search queries. A set of related navigational queries and corresponding URLs is then compiled by analyzing the query log. The set can comprise search queries issued within a predetermined period of time from the receipt of a navigational search query. Search queries are filtered from the set if they are not navigational search queries. The set of related search queries and corresponding URLs is presented in association with the URL corresponding to the navigational search query.

### BACKGROUND

Search queries are often issued by a user to a search engine. The search query may contain search terms that define information or other web sites that the user is seeking. Search queries may generally be classified as falling into one of two broad categories: discovery queries and navigational queries.

Discovery queries are issued by a user seeking information about a topic. Search results are then generated by the search engine according to one or more algorithms. Discovery queries are further characterized by the user seeking information from any source, and not any particular web site. For instance, a search query containing the element “Seattle” would be recognized as a discovery query. Multiple links to URLs may be generated by the search engine as a set of search results. Often a user may browse the search results and select results presented throughout the set of search results. Users may also select one link in the search result set and view the corresponding web site, only to discover that site did not provide the information they were seeking. The users may then return to the set of search results and select a link presented farther down in the list of search results.

Navigational queries are those issued by a user seeking to navigate to a specific web site. A search query of “Microsoft” would be recognized as a navigational query, as the user is likely seeking to navigate to the web site of the Microsoft Corporation, based in Redmond, Wash. Under most algorithms employed by search engines, a link to the URL of http://www.microsoft.com would be displayed as the first search result. While multiple search results may be generated by the search engine, often the user will click on the first search result presented and will not click on a link presented farther down the list. Additionally, it is unlikely that a user will return to the list of search results to select a link presented farther down in the list of search results.

Related URLs and corresponding web sites are defined to have similar content to that of a navigational search query and corresponding URL. For instance, if a navigational search query was directed to a major electronics retailer, a related URL and corresponding web site would be displayed for that of a competitor to the major electronics retailer.

### SUMMARY

Embodiments of the present invention relate to methods and computer-storage media for determining whether search queries are navigational search queries and presenting related search queries and corresponding URLs in association with search results for the navigational search queries. Query logs are analyzed to determine if a search query is a navigational search query. The query logs contain search queries issued by users and corresponding URLs selected in the search results. Navigational search queries and corresponding URL pairs are identified by applying one or more analytical methods upon the query logs.

Related search queries and corresponding URLs may be provided to a user issuing a navigational search query, in addition to a corresponding URL of the target of the navigational search query. The query log is consulted to determine which web sites are related to the navigational search query. By determining the identity of search queries issued within a predetermined time of the receipt of the navigational search query by other users, a set of related search queries and corresponding URLs may be determined. The query log may be consulted to determine which queries on the set are navigational queries, and queries determined to be non navigational queries may then be culled from the set. The remaining navigational search queries contained on the list may then be presented to the user issuing the navigational search query, along with the URL of the target of the navigational search query.

This Summary is provided to introduce a selection of concepts in a simplified form that are further described below in the Detailed Description. This Summary is not intended to identify key features or essential features of the claimed subject matter nor is it intended to be used to limit the scope of the claimed subject matter.

### BRIEF DESCRIPTION OF THE DRAWINGS

The present invention is described in detail below with reference to the attached drawing figures, wherein:

FIG. 1 is a block diagram of a computing system environment suitable for use in implementing embodiments of the present invention;

FIG. 2 is a block diagram illustrating an overview of a system in accordance with an embodiment of the invention;

FIG. 3 is a block diagram illustrating a sample query log in accordance with an embodiment of the invention;

FIG. 4 is a flow diagram illustrating a method for categorizing search queries as navigational search queries in accordance with an embodiment of the invention;

FIG. 5 is a flow diagram illustrating a method for presenting a link to related web sites in response to receiving a search query, in accordance with an embodiment of the invention;

FIG. 6 is a flow diagram illustrating a method in accordance with an embodiment of the invention for identifying a navigational search query and displaying related web sites in conjunction with a URL corresponding to the navigational search query; and

FIG. 7 is a screen shot of an exemplary search results web page for a navigational search query, according to one embodiment of the invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention are directed to methods and computer-readable media with computer-executable instructions embodied thereon for determining whether one or more search queries are navigational search queries and displaying links to related web sites in conjunction with a Uniform Resource Locator (URL) for the navigational search query. One embodiment of the invention involves receiving a query log containing a plurality of search queries and corresponding URLs selected from search results generated in response thereto. Analytical methods are employed on the query log to determine if a particular search query is a navigational search query. A URL corresponding to the navigational search query is also determined. Other embodiments of the invention are directed to determining related queries and corresponding URLs for navigational search queries received from a user. The query log is analyzed to determine related queries and corresponding URLs for the navigational search query. At least one related query and corresponding URL is then presented to the user in conjunction with the corresponding URL for the navigational search query.

Having briefly described an overview of embodiments of the present invention, an exemplary operating environment suitable for use in implementing embodiments of the present invention is described below.

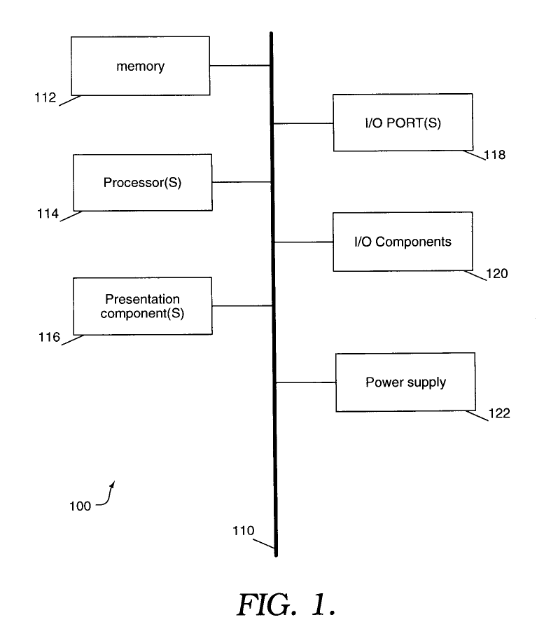

Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the illustrated computing environment be interpreted as having any dependency or requirement relating to any one or combination of components/modules illustrated.

The invention may be described in the general context of computer code or machine-useable instructions, including computer-executable instructions such as program components, being executed by a computer or other machine, such as a personal data assistant or other hand-held device. Generally, program components including routines, programs, objects, components, data structures, and the like, refer to code that performs particular tasks, or implements particular abstract data types. Embodiments of the present invention may be practiced in a variety of system configurations, including hand-held devices, consumer electronics, general-purpose computers, specialty-computing devices, and the like. Embodiments of the present invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computer” or “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, or any other medium that can be used to encode desired information and be accessed by computing device 100.

Memory 112 includes computer-storage media in the form of volatile and/or nonvolatile memory. The memory may be removable, non-removable, or a combination thereof. Exemplary hardware devices include solid-state memory, hard drives, optical-disk drives, and the like. Computing device 100 includes one or more processors that read data from various entities such as memory 112 or I/O components 120. Presentation component(s) 116 present data indications to a user or other device. Exemplary presentation components include a display device, speaker, printing component, vibrating component, etc. I/O ports 118 allow computing device 100 to be logically coupled to other devices including I/O components 120, some of which may be built in. Illustrative components include a microphone, joystick, game advertisement, satellite dish, scanner, printer, wireless device, and the like.

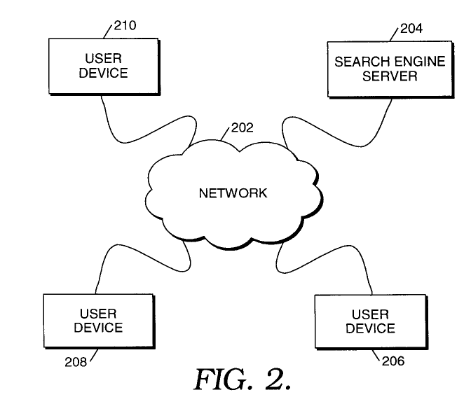

Turning now to FIG. 2, a block diagram is illustrated that shows an exemplary computing network system 200 configured to receive search queries presented by a user, in accordance with an embodiment of the present invention. It will be understood and appreciated by those of ordinary skill in the art that the computing network system 200 shown in FIG. 2 is merely an example of one suitable computing network environment and is not intended to suggest any limitation as to the scope of use or functionality of the present invention. Neither should the computing network system 200 be interpreted as having any dependency or requirement related to any single component/module or combination of components/modules illustrated therein.

Computing network system 200 includes user devices 206, 208, and 210, and search engine server 204 all in communication with one another via a network 202. The network 202 may include, without limitation, one or more local area networks (LANs) and/or wide area networks (WANs). Such networking environments are commonplace in offices, enterprise-wide computer networks, intranets, and the Internet. Accordingly, the network 202 is not further described herein.

User devices 206, 208, and 210 may be any type of computing device used by an end user. By way of example, and not limitation, user devices may be personal computers, PDAs, cell phones, smart phones, or any other computing device used by an end user. Common to the exemplars presented is the ability to receive a search query and communicate that query to the search engine server 204 through network 202.

While an end user may be an ordinary human user, other types of end users are contemplated as well. For instance, an end user may also be another computing application. Accordingly, an end user should not be construed as being limited to a human user.

Search engine server 204 receives search queries entered on user devices 206, 208, and 210 through network 202. The search queries may be entered into a depiction of a web site generated on the user devices 206, 208, and 210. Search queries may generally be grouped into one of two classifications: discovery search queries and navigational search queries.

Discovery search queries are oftentimes issued by a user seeking information about a topic. Search results are then generated by the search engine server 204 according to one or more search algorithms. Discovery search queries are further characterized by the user seeking information from any source, and not any particular web site. For instance, a search query containing the element “Seattle” would be recognized as a discovery query. Multiple links to URLs may be generated by the search engine server 204 as a list of search results. Often a user may browse the search results and select results presented throughout the list of search results. Users may also select one link in the search result and view the corresponding web site, only to discover that web site did not provide the information they were seeking. The users may then return to the list of search results and select a link presented farther down in the list of search results.

Navigational search queries are those issued by a user seeking to navigate to a specific web site. For instance, a user may enter the name of an entity or organization as a search query when they seek to be presented with a link to the entity or organizations web site. As such, a search query of “Microsoft” would be recognized as a navigational search query, as the user is likely seeking to navigate to the web site of the Microsoft Corporation, based in Redmond, Wash. Under most algorithms employed by search engines such as search engine server 204, a link to the URL of http://www.microsoft.com would be displayed as the first search result. While multiple search results may be generated by a search engine in response to a navigational search query, often the user will select the first search result presented and will not select a link presented farther down the list. Additionally, it is unlikely that a user will return to the list of search results to select a link presented farther down in the list of search results.

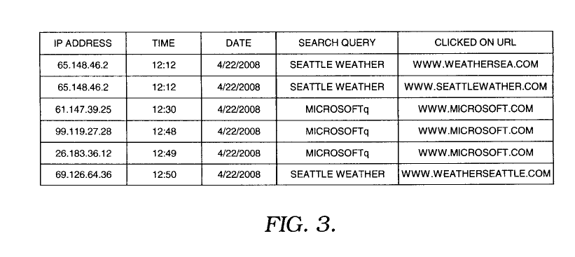

Returning to the discussion of the search engine server 204 of FIG. 2, after receiving the search query, the search engine server 204 then generates links to one or more URLs based on search algorithms and subsequently communicates those links as search results to the user devices 206, 208, and 210 through network 202. An end user may then select one or more of the search results to be directed to the web site corresponding to the URL selected in the search results. The user can make the selection through the use of a pointing device, such as a “mouse”, or through the user of any other input method. The search engine server 204 may track and record the identity of end users entering search queries, the search queries entered, URLs selected in the search results, and the time and date that the search query is issued and URLs selected. This information can be referred to as user session data and these records are collectively referred to as a query log, and are discussed further in relation to FIG. 3. In alternative embodiments of the invention a separate server, not depicted in FIG. 2, may collect and generate a query log by receiving communications through network 202 from search engine server 204.

Turning now to FIG. 3, an exemplary query log 300 is depicted. The columns of the query log 300 define the individual field of data recorded for each search query. The first field is the IP address of the user device from which the search query was issued. Fields for the time and date that the search queries were received by search engine server 204 are depicted. In other embodiments of the invention, additional time and date fields may represent the respective time and date that a search query was entered into the user device 206, 208, and 210. Although not depicted in FIG. 3, an additional time field may be provided in query log 300 for recording the time and date on which the URL was selected. Additional fields in the query log 300 provide for the recordation of the search query received from the user, as well as the URL selected in the search results. Each row of the query log provides a unique reference for an issuance of a search query by a user. This depiction of a query log 300 is provided for illustrative purposes only, and ones skilled in the art will understand that a query log may take nearly limitless forms. Further, query logs may contain more or less information than that presented in accordance with FIG. 3. One skilled in the art would recognize that information regarding a user's browsing history may also be included in a query log. Accordingly, the format and content presented in FIG. 3 should be interpreted as merely an example of one of many acceptable query log formats and content contained therein.

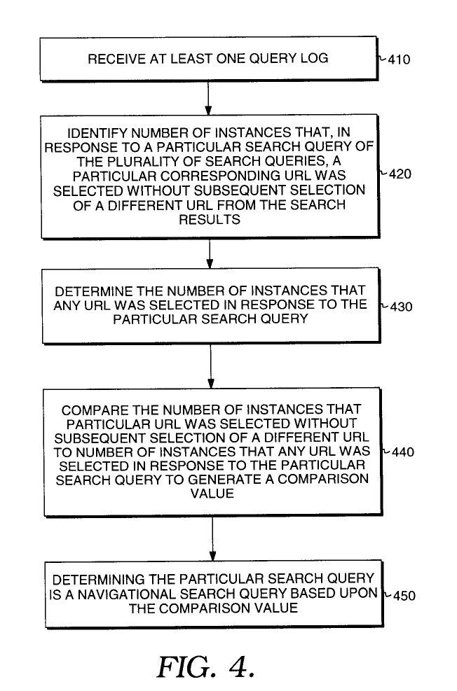

Turning now to FIG. 4, a flow diagram depicting a method of categorizing one or more search queries as navigational queries is presented. The method begins at block 410 with the receiving of at least one query log. For purposes of discussion, it will be assumed that one query log is received, although it should be recognized that multiple query logs may be received in accordance with embodiments of the invention. While block 410 references the receiving of a query log, the term ‘receiving’ should be understood to encompass the generation of a query log within the search engine server 204. In this manner, the query log may be ‘received’ by a different component of the search engine server 204 than the component that generated the query log. As discussed above in regard to FIG. 3, a query log generally contains the following pieces of information for each search query received: the identity of the user device from which the search query was received, the date and time of the reception or issuance of the search query, the elements of the search query, the URL(s) selected in response to the search query, and the date and time the URL(s) were selected in response to the search query. More or less information may be included in the query logs, according to varying embodiments of the present invention. As discussed above, the information contained within the query log may be collectively referred to as user session data.

In block 420, the number of instances that, in response to a particular search query of the plurality of search queries, a particular corresponding URL was selected without a subsequent selection of a different URL from the search results. A particular search query within the meaning of FIG. 4 may be a search query that is received from a user device 206, 208, or 210 by the search engine server 204. The methods described in relation to FIG. 4 may then be instituted to determine if a received search query may be properly determined to be a navigational search query. In accordance with block 420, the query log is analyzed to determine how many times a particular URL was selected in response to the particular search query. Although not depicted in FIG. 4, the portion of the method recited in relation to block 420 may be carried out for each URL that was clicked upon in search results generated for the particular search query. In this manner, each URL that was clicked upon in the search results may be a particular URL for the particular search query.

Simply put, although not explicitly depicted in FIG. 4, the methods recited in blocks 420, 430, 440, and 450 may be repeated for each URL that was selected in response to the particular search query. After completing the iterations for each URL that were selected, each URL will have been a particular URL at one time in the iterative process.

Proceeding on with FIG. 4, in block 430 a determination is made of the number of instances that any URL was selected in response to the particular search query. This determination is made by analyzing the entries of the query log in which the particular search query was issued. The number of distinct URLs selected in response to the particular search query can then be determined.

In block 440, a comparison is made to the number of instances that the particular URL was selected without a subsequent selection of a different URL to the number of instances that any URL was selected in response to the particular search to generate a comparison value. The comparison value can take the form of a ratio. Based upon the comparison value, the particular search query may be determined to be a navigational search query in block 450. The predefined percentage may vary considerably in practice and be regularly adjusted to provide optimal results. In some embodiments of the invention the percentage may be in the 40-50% range. Although it should be understood that in other embodiments of the invention, the percentage may vary significantly based on any number of factors. Those factors may include, but are not limited to: the total number of entries of the query log, the number of URLs selected in response to the particular search query, or the number of instances that the particular URL was selected in response to the particular search query. Accordingly, the range of percentages may vary considerably based on any number of factors.

The navigational search query can then be stored on computer-readable media in association with the particular corresponding URL. When search results are presented in response to the issuance of the navigational search query, at least one of a related query and a URL corresponding to a related query can be presented in association with the navigational search query and the particular corresponding URL.

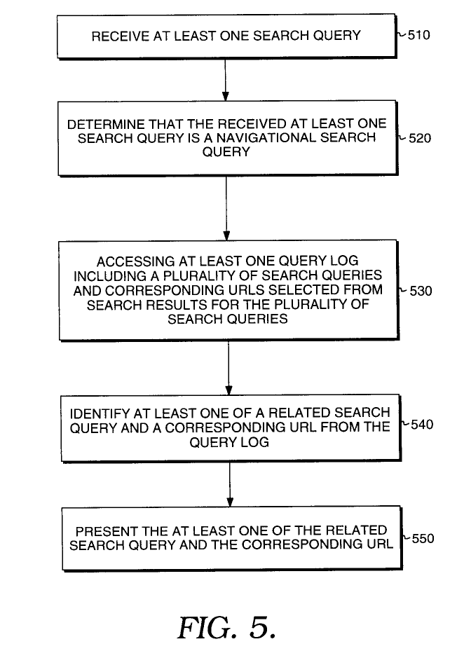

Turning now to FIG. 5, a flow diagram depicting a method of presenting a link to at least one related search query and corresponding URL in response to receiving at least one navigational search query is presented. Related search queries are those that are similar enough to the URLs corresponding to navigational search queries that a user has a likelihood of finding the information useful and/or relevant. For instance, if the navigational search query is directed to a particular major consumer electronic retailer, related search queries might be those directed to other electronic retailers.

The method begins at block 510 with the receiving of at least one search query. The search query may be entered into one of the user devices 206, 208, and 210 and communicated to the search engine server 204 through the network 202. Further discussion of FIG. 5 will refer to a single search query being received in block 510, although multiple search queries may be received in block 510.

At block 520, the search query received in block 510 is analyzed to determine if it is a navigational search query. Methods described in relation to FIG. 4 are utilized to determine whether the search query is a navigational search query and reference will therefore be made to FIG. 4. In general, the process of categorizing a search query as a navigational search query begins by determining the number of instances that a particular URL was selected in response to a particular search query that did not result in a subsequent click on a different URL in the search results is identified. A particular search query within the meaning of FIG. 5 is the search query received in block 510 and may be a search query that is received from a user device 206, 208, or 210 by the search engine server 204. Next, the query log is analyzed to determine how many times a particular URL was selected in response to the particular search query. Although not depicted in FIG. 5, the portion of the method recited in relation to block 530 may be carried out for each URL that was selected in search results generated for that particular search query. In this manner, each URL that was selected in the search results may be a particular URL for the particular search query.

Simply put, although not explicitly depicted in FIG. 4, the methods recited in blocks 420, 430, 440, and 450 may be repeated for each URL that was selected in response to the particular search query. After completing the iterations for each URL that was selected, each URL will have been a particular URL at one time in the iterative process.

A determination is then made of the number of instances that any URL was selected in response to the search query received at block 510. This determination is made by analyzing the entries of the query log in which the particular search query was issued. The number of distinct URLs selected in response to the particular search query can then be determined.

Further, the numbers identified and determined in blocks 420 and 430 are compared and a comparison value is generated. The comparison value can take the form of a ratio. If the ratio of the number of instances identified in block 420 to the number determined in block 430 exceed a predefined percentage, the particular search query is determined to be a navigational search query in block 520. The predefined percentage may vary considerably in practice and be regularly adjusted to provide optimal results. In some embodiments of the invention the percentage may be in the 40-50% range. Although it should be understood that in other embodiments of the invention the percentage may vary significantly based on any number of factors. Those factors may include, but are not limited to: the total number of entries of the query log, the number of URLs selected in response to the particular search query, or the number of instances that the particular URL was selected in response to the particular search query. Accordingly, the range of percentages may vary considerably based on any number of factors.

In block 530, a query log containing at least one such query is accessed. For purposes of discussion, it will be assumed that one query log is accessed, although it should be recognized that multiple query logs may be accessed in accordance with embodiments of the invention. As discussed above in regard to FIG. 3, a query log generally contains the following pieces of information for each search query received: the identity of the user device from which the search query was received, the date and time of the reception or issuance of the search query, the elements of the search query, the URL(s) selected in response to the search query, and the date and time on which the URL(s) were selected in response to the search query. More or less information may be included in the query logs, according to varying embodiments of the present invention.

In block 540, at least one related search query and a corresponding URL is identified. Related queries and corresponding URLs may be identified by analyzing the query log to determine queries issued by a user within a predetermined period of time from the same user issuing the navigational query. A set may then be generated of prospective related search queries and corresponding URLs. The search queries and corresponding URLs in the set may then be analyzed to determine if they are navigational search queries and related URLs. In some embodiments of the invention, queries and URLs may be filtered from the set if they are not navigational search queries and corresponding URLs. A filtered set is thereby generated that contains related search queries and corresponding URLs that are also navigational search queries. This filtered set, or some portion thereof, can then be presented in association with the navigational search and corresponding URL.

Alternative embodiments of the invention may retain the queries and URLs in the set, regardless of the status of the query as a navigational search query. In these embodiments, a determination may not even be made as to whether or not the search queries and URLs are navigational search queries and corresponding URLs.

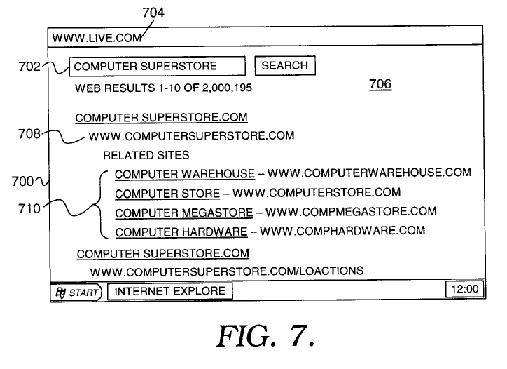

At block 550, at least one of the related search query and the corresponding URL link is presented. The at least one of the related search query and corresponding URL may be presented in association with the corresponding URL for the navigational search query in the search results. The at least one of the related search query and corresponding URL may be presented directly beneath the link to the corresponding URL for the navigational search query. In addition, multiple links to related search queries and/or navigational search queries may be displayed in conjunction to the corresponding URL for the navigational search query. A visual depiction of the arrangement of the link to related web sites is presented in FIG. 7 and will be discussed to a greater extent in conjunction therewith. It should be understood however that only the related search query or only the corresponding URL may be presented with the navigational search query. In addition, both the related search query and corresponding URL may presented in association with the navigational search query.

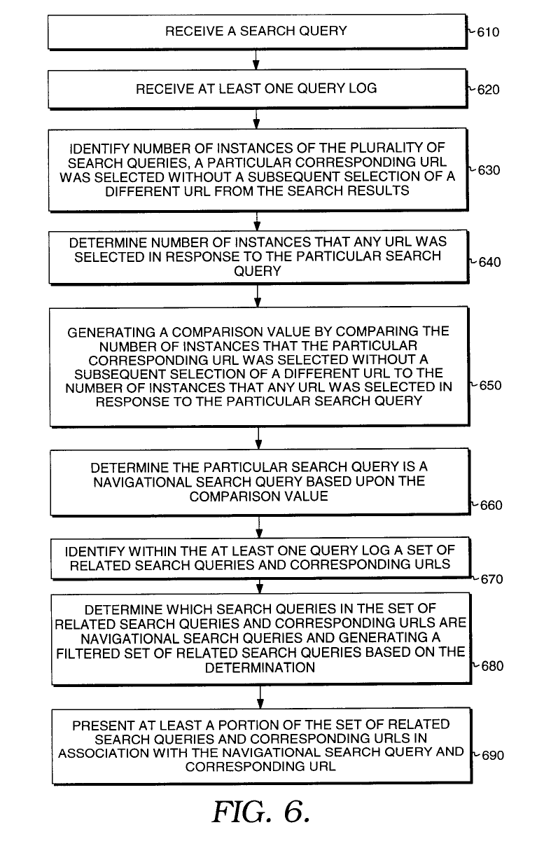

Turning now to FIG. 6, a depiction is presented of a flow diagram for a method of identifying a navigational search query and displaying a related search query and/or corresponding URL in association with a URL corresponding to the navigational search query is presented, according to one embodiment of the invention.

The method begins in block 610 with the receiving of a search query. The search query may be received from any of user devices 206, 208, and 210 after being communicated through network 202 to search engine server 204.

A query log is then received in block 620, in a similar fashion related in conjunction with block 410 of FIG. 4 and block 520 of FIG. 5. For purposes of discussion, it will be assumed that one query log is received, although it should be recognized that multiple query logs may be received in accordance with embodiments of the invention. While block 620 references the receiving of a query log, the term ‘receiving’ should be understood to encompass the generation of a query log within the search engine server 204. In this manner, the query log may be ‘received’ by a different component of the search engine server 204 than the component that generated the query log. As discussed above in regard to FIG. 3, a query log generally contains the following pieces of information for each search query received: the identity of the user device from which the search query was received, the date and time of the reception or issuance of the search query, the elements of the search query, the URL(s) selected in response to the search query, and the date and time on which the URL(s) were selected in response to the search query. More or less information may be included in the query logs, according to varying embodiments of the present invention.

In block 630, the number of instances that, in response to a particular search query of the plurality of search queries, a particular corresponding URL was selected without a subsequent selection of a different URL from the search results.

In accordance with block 640, the query log is analyzed to determine the number of instances that any URL was selected in response to the particular search query. This determination is made by analyzing the entries of the query log in which the particular search query was issued. The number of distinct URLs selected in response to the particular search query is then determined. Although not depicted in FIG. 6, the portion of the method recited in relation to block 640 may be carried out for each URL that was clicked upon in search results generated for the search query. In this manner, each URL that was clicked upon in the search results may be a particular URL for the particular search query.

Simply put, although not explicitly depicted in FIG. 6, the methods recited in blocks 630, 640, 650, and 660 may be repeated for each URL that was clicked upon in response to the search query received in block 610. After completing the iterations for each URL that was selected, each URL will have been a particular URL at one time in the iterative process.

In block 650, a comparison value is generated by comparing the number of instances that the particular corresponding URL was selected without a subsequent selection of a different URL to the number of instances that any URL was selected in response to the particular search query to generate a comparison value.

In block 660, the particular search query is determined to be a navigational search query based upon the comparison value. This comparison value can take the form of a ratio. If the ratio exceeds a predefined percentage, the search query can be determined to be a navigational search query. The predefined percentage may vary considerably in practice and be regularly adjusted to provide optimal results. In some embodiments of the invention the percentage may be in the 40-50% range. Although it should be understood that in other embodiments of the invention, the percentage may vary significantly based on any number of factors. Those factors may include, but are not limited to: the total number of entries of the query log, the number of URLs selected in response to the particular search query, or the number of instances that the particular URL was selected in response to the particular search query. Accordingly, the range of percentages may vary considerably based on any number of factors.

In block 670, a set of related search queries and corresponding URLs is identified within the at least one query log. Related queries and URLs may be identified by analyzing the query log to determine queries issued by other users within a predetermined period of time from when they issued the same user issuing the navigational query. A set may then be generated of prospective related queries and URLs.

At block 680, a determination is made as to which queries and URLs in the set are navigational search queries and corresponding related URLs. Although not depicted in FIG. 6, this determination is made by utilizing methods presented in blocks 630, 640, and 650. Queries and URLs are then removed from the set if they are not navigational search queries and corresponding URLs. A filtered set is thereby generated, containing only related search queries and corresponding related URLs that are also navigational in nature.

At least a portion of the set of related queries and URLs are presented to the user in association with the navigational search query and corresponding URL in block 690. The set may be presented directly beneath the corresponding URL for the navigational search query. A visual depiction of the arrangement of the link to related web sites is presented in FIG. 7 and will be discussed to a greater extent in conjunction therewith.

Turning now to FIG. 7, a depiction of an exemplary screen shot of a search results web page for a navigational search query is presented, according to one embodiment of the invention. The user interface 700 is a display of a user device 206, 208, and 210. An internet web browser 704 is depicted, along with a search results web page 706. The navigational search query “Computer Superstore” 702 is presented as well. The corresponding URL 708 of “www.computersuperstore.com” is presented as the corresponding URL to the navigational search query 702. Immediately beneath the corresponding URL 708 are a number of related search queries 710. Although not depicted in FIG. 7, the related search queries 710 may be displayed in a different font than the corresponding URL 708, or they may also be displayed in a different text color than the corresponding URL 708. FIG. 7 is presented as an example only, and many different configurations in accordance with alternative embodiments of the invention are available for displaying the related search queries in conjunction with the corresponding URL of the navigational search query. The depiction in FIG. 7 is not intended to be a definitive example or a preferred embodiment.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

The invention claimed is:

1. A method of categorizing search queries as navigational search queries, the method comprising:
receiving at least one query log including a plurality of search queries and corresponding Uniform Resource Locators (URLs) selected from search results generated in response thereto;
identifying a number of instances that, in response to a particular search query of the plurality of search queries, a particular corresponding URL was selected without a subsequent selection of a different URL from the search results;
determining a number of instances that any URL was selected in response to the particular search query;
comparing the number of instances that the particular URL was selected without a subsequent selection of a different URL to the number of instances that any URL was selected in response to the particular search query to generate a comparison value; and
determining the particular search query is a navigational search query based upon the comparison value.

2. The method of claim 1, wherein the navigational search query is stored in association with the particular corresponding URL.

3. The method of claim 1, further comprising:
presenting at least one of a related query and a URL corresponding to a related query in association with the navigational search query and the particular corresponding URL.

4. The method of claim 3, wherein the at least one query log further includes user session data, and wherein the related query and URL corresponding thereto are determined by analyzing the user session data from the at least one query log.

5. The method of claim 4, wherein the user session data comprises user identifiers, pairs of search queries and URLs selected in response thereto, and time indicators for the search queries and URL selections.

6. The method of claim 1,
wherein comparing the number of instances that the particular corresponding URL was selected without a subsequent selection of a different URL to the number of instances that any URL was selected in response to the particular search query to generate a comparison value comprises determining a ratio of the number of instances that the particular corresponding URL was selected in response to the particular search query without selection of a different URL from the search results to the number of instances that any URL was selected in response to the particular search query,
and wherein determining the particular search query is a navigational search query based upon the comparison value comprises determining the particular search query is a navigational search query when the determined ratio meets or exceeds a predefined value.

7. A method of presenting search queries that are related to navigational search queries, the method comprising:
receiving at least one search query;
determining that the received at least one search query is a navigational search query;
accessing at least one query log including a plurality of search queries and corresponding Uniform Resource Locators (URLs) selected from search results for the plurality of search queries;
identifying at least one of a related search query and a corresponding URL from the query log; and
presenting the at least one of the related search query and the corresponding URL.

8. The method of claim 7, wherein presenting the at least one of the related search query and the corresponding URL comprises presenting the related search query and the corresponding URL in association with one another.

9. The method of claim 7, further comprising determining a URL that corresponds to the at least one navigational search query.

10. The method of claim 9, further comprising presenting the at least one of the related search query and corresponding URL in association with at least one of the received navigational search query and the determined corresponding URL.

11. The method of claim 7, wherein identifying at least one of a related search query and a corresponding URL from the query log comprises:
analyzing the at least one query log to determine other search queries issued within a predetermined time frame relative to receipt of the navigational search query; and
classifying the other search queries issued within the predetermined time frame as related search queries.

12. The method of claim 11, further comprising generating a set of related search queries, the set comprising search queries classified as related queries and URLs that correspond to the related search queries.

13. The method of claim 12, further comprising determining which related search queries from the set of related search queries are navigational search queries.

14. The method of claim 13, further comprising generating a filtered set of related search queries based upon the determination of which are navigational search queries.

15. The method of claim 14, further comprising:
determining a URL corresponding to the at least one navigational search query; and
presenting at least a portion of the filtered set of related search queries and corresponding URLs in association with the at least one navigational search query and corresponding URL.

16. One or more computer-storage media with computer-executable instructions embodied thereon for performing a method of identifying navigational search queries and presenting related search queries and/or corresponding URLs in association with URLs corresponding to the navigational search queries, the method comprising:
receiving a search query;
receiving at least one query log;
identifying a number of instances that, in response to a particular search query of the plurality of search queries, a particular corresponding URL was selected without a subsequent selection of a different URL from the search results;
determining a number of instances that any URL was selected in response to the particular search query;
generating a comparison value by comparing the number of instances that the particular corresponding URL was selected without a subsequent selection of a different URL to the number of instances that any URL was selected in response to the particular search query;
determining the particular search query is a navigational search query based upon the comparison value;
identifying within the at least one query log a set of related search queries and corresponding URLs;
determining which search queries in the set of related search queries and corresponding URLs are navigational search queries and generating a filtered set of related search queries based upon the determination; and
presenting at least a portion of the set of related search queries and corresponding URLs in association with the navigational search query and corresponding URL.

17. The method of claim 16, wherein the query log includes a plurality of search queries and corresponding URLs selected from search results generated for the search queries.

18. The method of claim 16, wherein the identifying a set of related search queries and corresponding URLs comprises:
analyzing the at least one query log to determine other search queries issued by a user within a predetermined time frame relative to receipt of the navigational search query from the same user; and classifying the other search queries issued within the predetermined time frame as related search queries.

19. The method of claim 16, wherein determining the particular search query is a navigational search query comprises calculating a ratio of the number of instances that the particular corresponding URL was selected in response to the particular search query without selection of a different URL from the search results to the number of instances that any URL was selected in response to the particular search query.

20. The method of claim 19, wherein the particular search query is determined to be a navigational search query when the ratio meets or exceeds a predefined value.
